(19) United States
(12) Patent Application Publication
(10) Pub. No.: US 2025/0378414 A1
(43) Pub. Date: Dec. 11, 2025

(54) BOX FOR THE SUPPLY OF FOOD PRODUCTS FOR DYSPHAGIC USERS

(71) Applicant: Giovan Battista VAROLI, Bagnone (MS) (IT)

(72) Inventor: Giovan Battista VAROLI, Bagnone (MS) (IT)

(21) Appl. No.: 18/875,096

(22) PCT Filed: Jun. 15, 2023
(86) PCT No.: PCT/IB2023/056210

§ 371 Date: Dec. 13, 2024

(30) Foreign Application Priority Data
Jun. 15, 2022 (IT) 102022000012635
Jun. 15, 2022 (IT) 102022000012647

(51) Int. Cl. G06Q 10/083

(52) U.S. Cl. CPC G06Q 10/083

(57) ABSTRACT

A box for the supply of food products for dysphagic users comprising a plurality of cases organized in layers, each containing at least one food product to be supplied to a dysphagic user and which can be picked up by means of an access opening, and a container which defines at least one housing compartment of the plurality of cases and a pickup opening. Moreover, the cases of the first set are distributed in a respective first layer and the cases of the second set are distributed in a respective second layer. Further, the first layer is positioned between the pickup opening and the second layer and each individual case can be picked up at a first time range and a case adjacent thereto can be picked up at a second time range, subsequently to the first time range.

### TECHNICAL FIELD

The present invention relates to a box for the supply of food products for dysphagic users.

Although the present invention finds a preferred, but not exclusive, application in the context of the supply of food products to dysphagic individuals, the box can be used in any situation wherein the food products to be supplied are to be consumed according to a predetermined dietary regimen, such as e.g. through appropriate food diets.

### BACKGROUND ART

Dysphagia is a condition that consists of objective difficulty in swallowing solid or liquid food, accompanied by regurgitation and by the risk of portions of food passing to the respiratory tract.

In such conditions, therefore, dysphagic individuals tend to lose interest in proper and sufficient nutrition, which can lead them to dehydration, hypo-nutrition and/or malnutrition.

Dysphagic individuals, at least in the early stages when this condition develops, must be accompanied in feeding to avoid the aforementioned issues.

Specifically, foods are generally prepared in accordance with the guidelines drawn up by the International Dysphagia Diet Standardization Initiative (IDDSI). According to this initiative, based on the severity of dysfunction in a person, foods and drinks are prepared to achieve a predetermined degree of viscosity. In the case of traditional foods, these are shredded/minced until the desired degree is achieved.

Dietary compositions for dysphagic individuals are therefore formulated to provide a high amount of nutrients in a reduced amount of administered food.

In the case, however, of powdered food compositions, which are to be reconstituted, the degree of viscosity is predetermined by accurately dosing a predefined amount of powder with a predefined amount of reconstitution liquid.

Therefore, the preparation of meals for dysphagic users turns out to be a very delicate operation and, for this reason, the greatest problems and complexities arise when the person is at home generally assisted by non-health care personnel and therefore unskilled for the preparation of meals for dysphagic persons in addition to not knowing how to deal with critical situations that may arise in the case of improper meal preparation. Manual preparation of homogeneous products is extremely complex and, if done by an unskilled person, cannot ensure adequate consistencies and certain nutritional intake.

To partly overcome these problems, special industrial preparations are known which, however, have extremely high production, and therefore sales, costs, in addition to having limited nutritional intake.

There are also home solutions or solutions which can be used in health centers in which dysphagic users are supplied with food compositions starting from dehydrated powdered preparations to be reconstituted, the degree of viscosity of which is predetermined by dosing the water used as reconstitution liquid in a very approximate manner.

### DESCRIPTION OF THE INVENTION

It was therefore planned to create a box for the supply of food products structured in such a way as to allow easy and intuitive preparation of meals for dysphagic users by non-expert personnel, while at the same time ensuring repeatability of textures and certain nutritional intake.

It follows that the main aim of the present invention is to create a box for the supply of food products which is able to promote the preparation of meals for dysphagic users, ensuring certainty in nutritional intake, consistency in homogeneity and optimal texture.

Another object of the present invention is to devise a box for the supply of food products which is intuitive and user-friendly.

A further object of the present invention is to devise a box for the supply of food products which can make the preparation of food products practical, simple, quick and affordable for everyone as well as safe from a rheological and nutritional point of view.

Another object of the present invention is to devise a box for the supply of food products which can overcome the aforementioned drawbacks of the prior art within the framework of a simple, rational, easy and effective to use as well as affordable solution.

The above objects are achieved by this box for the supply of food products having the characteristics of claim 1.

In addition, the above objects are achieved by a distribution kit in accordance with claim 11.

### LIST OF THE DRAWINGS

Other characteristics and advantages of the present invention will become more apparent from the description of a preferred, but not exclusive, embodiment of a box for the supply of food products, illustrated by way of an indicative, yet non-limiting example, in the accompanying tables of drawings in which:

FIG. 1 is a perspective view of the box for the supply of food products in accordance with the present invention wherein the cases of each layer are sorted by day of the week,

FIG. 2 is a partially exploded view of the box in FIG. 1 wherein the first layer of cases is lifted up and the container of the box is in transparency to show the layers of the cases underneath,

FIG. 3 is a view of the box in FIG. 1 wherein the cases of each layer are sorted by flow type,

FIG. 4 is a partially exploded view of the box in FIG. 3 wherein the first layer of cases is lifted up and the container of the box is in transparency to show the layers of the cases underneath,

FIGS. 5 and 6 are perspective views of embodiments wherein the seven cases of a given week are contained in relevant weekly boxes which are in turn contained in the box of the invention,

FIGS. 7 and 8 are perspective views of embodiments wherein the seven cases of a given flow type are contained in relevant boxes which are themselves contained in the box of the invention,

FIGS. 9 and 11 are detailed perspective views of a case relating to a day of the week containing one sachet and of a case relating to a specific type of dish containing a plurality of sachets, respectively,

FIGS. 10 and 12 are perspective views of the kit for the distribution of food products.

### EMBODIMENTS OF THE INVENTION

With particular reference to these figures, reference numeral 1 globally denotes a box for the supply of food products for dysphagic users.

The box 1 makes it possible to supply a dysphagic user with food products to be enjoyed according to a predefined dietary or food regimen by facilitating the proper preparation of meals and/or drinks.

Such a box 1 is preferably intended for home use so as to allow for the preparation even for inexperienced users of meals and/or drinks having appropriate rheometric characteristics, certain nutritional intakes, consistency in homogeneity and optimal texture to facilitate swallowing and, at the same time, ensure hydration and nutrition corresponding to the needs of the dysphagic user.

The box can also be used by operating staff in health or care centers for dysphagic users.

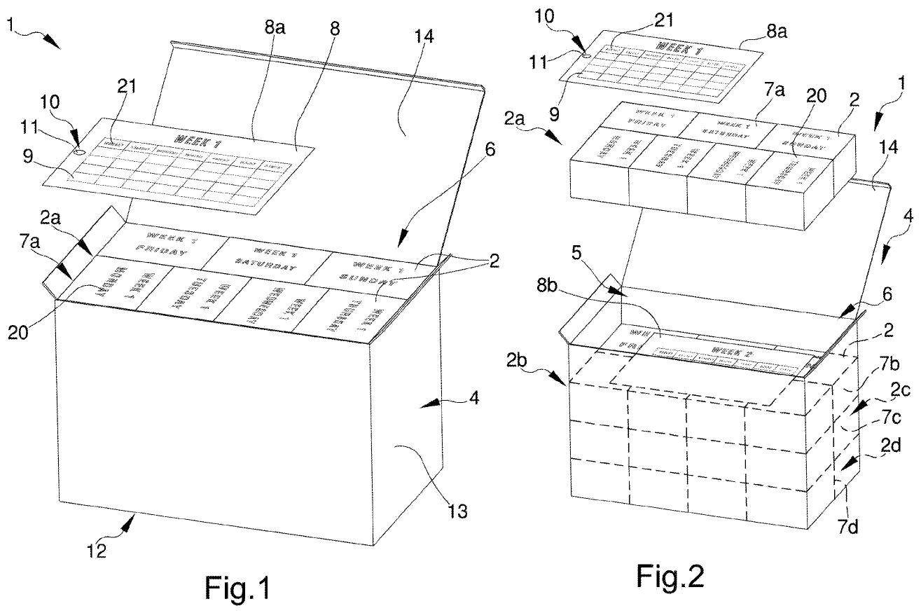

As visible from FIG. 1, the box 1 comprises a plurality of cases 2 which in turn comprise a plurality of sachets 19, each sachet 19 containing at least one food product to be supplied to a dysphagic user. The cases can be picked up by means of an access opening 3, preferably resealable.

As will be described in detail later in the description, the sachets 19 can contain at least one type of food products out of the following:
food products for hydration,
food products for breakfast,
food products for lunch,
food products for snack,
food products for dinner.

In this instance, the plurality of cases 2 comprises:
a first set of cases 2a, and
a second set of cases 2b.

Preferably,
the first set of cases 2a can be picked up at a first time range, and
the second set of cases 2b can be picked up at a second time range, subsequently to the first time range.

According to the invention, therefore, the cases 2 are grouped into a plurality of sets of cases 2, each set of cases 2a, 2b being intended to be picked up in a predetermined time range.

It should also be specified that each individual case 2 can also be picked up at a first time range and a case 2 adjacent thereto can be picked up at a second time range, subsequently to the first time range. In this context, the pickup time range between the sets of cases 2 may have a short duration of tens of minutes or one or more hours, or a longer duration of a day, a week, a month, a year, etc. For example, with reference to FIG. 1 the pickup time range between each case 2 belonging to the same layer 7a, 7b, 7c, 7d has a preferred duration of one day while the pickup time range between the sets of cases 2 has a preferred duration of one week.

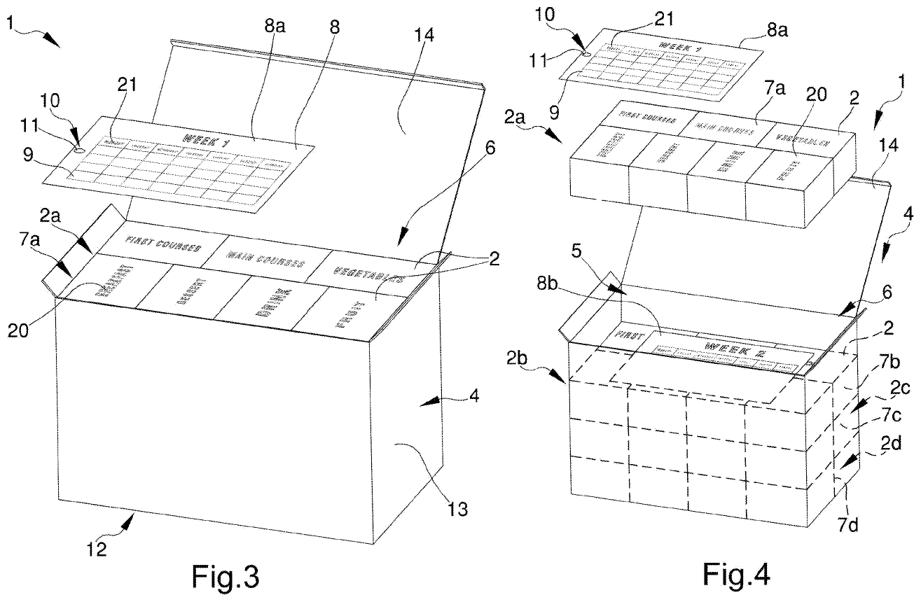

Referring to the example in FIG. 3, the pickup time range between each case 2 belonging to the same layer 7a, 7b, 7c, 7d has a preferred short duration corresponding to one or more minutes or one or more hours, while the pickup time range between the sets of cases 2 has a preferred duration of one week. In actual facts, each case 2 belonging to the same layer 7a, 7b, 7c, 7d is intended to be opened during the same meal.

Usually, these time ranges are predetermined by the dietary or food regimen to be followed by the dysphagic user.

Conveniently, the box 1 comprises a container 4 which defines at least one housing compartment 5 of the plurality of cases 2 and a pickup opening 6. The pickup opening 6 is adapted to allow the dysphagic user to pick up the cases 2 from the housing compartment 5.

In this instance, the pickup opening 6 is communicating with the housing compartment 5.

Preferably, the pickup opening 6 is formed superiorly to the housing compartment 5. Specifically, the pickup opening 6 is formed opposite a bottom wall 12 of the container 4.

In the context of this disclosure, the terms “upper”, “lower”, “vertical” and “horizontal”, used with reference to the box 1, are intended to be referred to the conditions under which the box 1 is normally used, i.e., those shown in the figures wherein it is arranged with the pickup opening 6 facing upwards.

It cannot, however, be ruled out that the pickup opening 6 can be obtained laterally or that the box 1 can be arranged with the pickup opening 6 facing laterally.

As visible in FIG. 2 or 4, the cases 2 of the first set 2a are distributed in a respective first layer 7a and the cases 2 of the second set 2b are distributed in a respective second layer 7b. In other words, the sets of cases are stacked along a stacking direction on a first and on a second layer 7a, 7b. This stacking direction extends between the bottom wall of the container and the pickup opening 6 vertically.

The term “layer” is used to denote a configuration wherein multiple cases 2 are arranged side by side in substantially the same plane transverse to the stacking direction.

Advantageously, the first layer 7a, i.e., the first set of cases 2a, is positioned between the pickup opening 6 and the second layer 7b, i.e., the second set of cases 2b. In other words, the first layer 7a, being intended to be picked up before the second layer 7b, is moved close to the picking opening 6 with respect to the second layer 7b.

Preferably, the box 1 comprises a plurality of sets of cases 2a, 2b, 2c, 2d, each intended to be enjoyed in a relevant time range. In accordance with the foregoing, the plurality of sets of boxes 2a, 2b, 2c, 2d are distributed in a plurality of respective layers 7a, 7b, 7c, 7d. These layers are arranged in the housing compartment 5 stacked one on top of the other along the stacking direction. Specifically, the layers 7a, 7b, 7c, 7d are arranged according to the order of enjoyment starting from the pickup opening 6 towards the bottom wall 12. In this instance, the closest or nearer layer 7a to the picking opening 6 comprises the set of cases 2a intended to be picked up at a first time range, the farthest layer 7d from the pickup opening 6 comprises the set of cases 2d intended to be picked up in the last time range.

In actual facts, the set of cases 2 intended to be picked up in a predetermined time range is positioned between the pickup opening 6 and the set of cases intended to be picked up in a subsequent time range to the predetermined time range. In the event of the pickup opening 6 being arranged superiorly, the set of cases intended to be picked up in a predetermined time range is arranged superiorly to the set of cases 2 intended to be picked up in a subsequent time range to the predetermined time range.

For example, in the case of monthly consumption, the closest or nearer layer 7a to the pickup opening 6 comprises the set of cases 2a intended to be picked up in the first week of the month, the layer 7b comprises the set of cases 2b which can be picked up in the second week of the month, and so on.

Appropriately, the box 1 comprises at least one package leaflet 8 associated with at least one of the sets of cases 2a-2d and positioned between the set of cases 2a-2d and the pickup opening 6.

Specifically, the box 1 comprises a plurality of package leaflets 8a-8d, each associated with a related set of cases 2a-2d. In this instance, the box 1 comprises at least a first package leaflet 8a, associated with the first set of cases 2a, and a second package leaflet 8b associated with the second set of cases 2b. The first package leaflet 8a is positioned between the pickup opening 6 and the first layer 7a. On the other hand, the second package leaflet 8b is positioned between the first and the second layers 7a, 7b, i.e., between the first and the second sets of cases 2a, 2b.

Conveniently, each package leaflet 8a-8d is arranged in support of the respective set of cases 2a-2d. In actual facts, in the case wherein the pickup opening 6 is arranged superiorly to the housing compartment 5, each package leaflet 8a-8d is arranged superiorly to the respective set of cases 2a-2d. Each package leaflet substantially operates as a divider between the layers.

In actual facts, each package leaflet 8a-8d is adapted, in use, to at least partly cover the relevant set of cases 2a-2d, i.e., the relevant layer.

As described in detail in the following description, preferably, the package leaflet has a shape which is substantially complementary to a horizontal section of the housing compartment 5.

This arrangement of the package leaflets means that the dysphagic user, before being able to pick up a predetermined set of cases 2, must necessarily pick up the relevant package leaflet so that he or she has all the information needed for the proper enjoyment of the food products.

Conveniently, the package leaflet bears at least one piece of information instruction 9 concerning the products contained in the relevant set of cases 2.

In particular, the package leaflet comprises at least one area where the information instruction 9 is applied.

Preferably, the information instruction 9 represents a set of instructions regarding when and/or how the dysphagic user is to enjoy the products contained in the relevant set of cases 2 to prepare meals and/or drinks.

The package leaflet can be composed of one or more sheets, a leaflet, a card and the like.

Preferably, the package leaflet may show:
a detailed menu of the meals and/or drinks to be prepared and the times at which to take them,
how and/or when to use the food products to prepare meals and/or drinks,
the amount of a predetermined food product to be used for meal and/or drink preparation,
the nutritional intakes and weights of the food products to be used for meal and/or drink preparation,
the nutritional information of the food products,
the food plan or diet to be followed by the dysphagic user, the reference to the time range and/or period in which the relevant set of cases 2 is to be enjoyed.

Specifically, the first and second package leaflets 8a, 8b show information regarding how and/or when to enjoy the products contained in the cases 2, the first and second set of cases 2a, 2b, respectively.

Usefully, the package leaflet may comprise a connecting means 10 adapted to allow its connection, e.g., to a wall.

Preferably, the connecting means 10 comprises an opening 11, preferably of the eyelet type, cut out on the package leaflet and adapted to receive a hook, rod, nail, and/or the like for hanging it on the wall.

As visible in FIG. 2 or 4, each set of cases 2a-2d comprises at least a first case 2, intended to be opened at a first time period, and a second case 2 intended to be opened at a second time period, subsequently to the first time period. The first and the second case 2 are arranged side by side to make the relevant layer. Specifically, the first and the second case 2 are arranged side by side on substantially the same plane, preferably parallel to the bottom wall and transverse to the stacking direction.

Preferably, each set of cases 2a-2d comprises a plurality of cases 2, each case 2 containing at least one product intended to be opened in a predetermined time period within the relevant time range wherein the set of cases 2 is to be enjoyed. In actual facts, each set of cases 2a-2d is intended to be enjoyed by the dysphagic user in a predetermined time range. Each case 2 of each set of cases 2a-2d is intended to be enjoyed in a predetermined time period within the relevant time range.

According to an example in which the time range is one week, the time period in which each case 2 is intended to be opened is one day of that week.

In accordance with the embodiment illustrated in the example in FIG. 3, all cases 2 of a relevant layer 7a, 7b, 7c, 7d are intended to be always opened substantially at the same time period of the day (e.g., lunch or dinner).

As visible in FIG. 2 or 4, the cases 2 of each set of cases 2a-2d are arranged side by side to define the relevant layer. In particular, the cases 2 of each set are arranged in the same plane, preferably substantially parallel to the bottom wall 12.

As anticipated above, in the preferred embodiment, the box 1 is used to distribute products to be enjoyed according to a monthly pattern. In other words, the products packaged in the plurality of cases 2 are intended to be enjoyed during a total period of one month's duration.

For simplicity of description, the following will refer to the case where the products are to be enjoyed during a month consisting of four weeks, each week being composed of seven days. It is clear that the box 1 is adaptable to additional time patterns in which a different number of time ranges and periods are present, and the latter have different durations.

In such an embodiment, the time range has a duration of one week and the time period is one day.

For this purpose, the plurality of cases 2 comprises four sets of cases 2. In other words, in addition to the first and second sets of cases 2a, 2b, the plurality of cases 2 comprises:
a third set of cases 2c intended to be picked up at a third time range, subsequently to the second time range, and
a fourth set of cases 2d intended to be picked up at a fourth time range, subsequently to the third time range.

Each set of cases 2a-2d is intended to be picked up during one of the weeks of the month. Specifically, the first 2a, the second 2b, the third 2c and the fourth 2d set of cases are intended to be picked up in the first, second, third and fourth weeks of a month, respectively.

In such an embodiment, the cases 2 of the third set of cases 2c are distributed in a respective third layer 7c and the cases 2 of the fourth set of cases 2d are distributed in a respective fourth layer 7d. The third layer 7c is positioned between the second layer 7b and the fourth layer 7d. On the other hand, the fourth layer 7d is positioned between the bottom wall 12 and the third layer 7c.

In actual facts, the sets of cases 2 are arranged in the housing compartment 5 in four layers where the first layer 7a is positioned between the pickup opening 6 and the second layer 7b, the latter being positioned between the first layer 7a and the third layer 7c. In turn, the third layer 7c is positioned between the second layer 7b and the fourth layer 7d. Preferably, the fourth layer 7d, being the last one, is arranged resting on the bottom wall 12 of the container 4.

As can be seen from FIG. 2, each set of cases 2 has seven cases 2. Each of the seven cases 2 is intended to be opened on a day of the week when the corresponding set of cases 2 is to be enjoyed.

Instead, as can be observed in the example in FIG. 4, each of the seven cases 2 is intended to be opened during the same meal.

In accordance with the embodiment shown in the example in FIG. 3, 4 or 11, the box 1 has seven cases 2 wherein:
the first case 2 “BREAKFAST” contains seven sachets 19,
the second case 2 “FIRST COURSE” contains fourteen sachets 19,
the third case 2 “MAIN COURSE” contains fourteen sachets 19,
the fourth case 2 “VEGETABLES” contains fourteen sachets 19,
the fifth case 2 “DESSERT” contains seven sachets 19,
the sixth case 2 “FRUIT” contains seven sachets 19, and
the seventh case 2 “DRINK” contains thirty-five sachets 19.

A different number of sachets in the various cases cannot however be ruled out, preferably, at most, seven or multiples thereof.

Preferably, each sachet 19 weighs between 150 g and 350 g, specifically:
the sachets 19 of the “BREAKFAST” weigh about 150 g,
the sachets 19 of the “FIRST COURSES” weigh about 250 g,
the sachets 19 of the “MAIN COURSES” weigh about 250 g,
the sachets 19 of the “VEGETABLES” weigh about 150 g,
the sachets 19 of the “DESSERT” weigh about 150 g,
the sachets 19 of the “FRUIT” weigh about 150 g,
the sachets 19 of the “DRINK” weigh about 150 g.

Usefully, the box 1 comprises four package leaflets 8a-8d, each associated with one of the sets of cases 2a-2d. In the present case, the box 1 comprises, in addition to the first and to the second package leaflets 8a, 8b, a third and fourth package leaflets associated with the third and fourth sets of cases 2c, 2d, respectively. The first package leaflet 8a is positioned between the pickup opening 6 and the first set of cases 2a. The second package leaflet 8b is positioned between the first set of cases 2a and the second set of cases 2b. The third package leaflet is positioned between the second set of cases 2b and the third set of cases 2c. The fourth package leaflet is positioned between the third set of cases 2c and the fourth set of cases 2d.

As can be seen in FIG. 1 or 3, the container 4 has a substantially parallelepiped shape, preferably in a square or rectangular plan. It cannot however be ruled out that the container 4 may have different conformations, such as prism-like in triangular or cylindrical plan.

Specifically, the container 4 comprises at least one side wall 13 and one bottom wall 12 which define the housing compartment 5. Specifically, the side wall 13 laterally bounds the housing compartment 5 and the bottom wall 12 is arranged transversely to the side wall 13 to close the housing compartment 5 inferiorly.

Preferably, the container 4 has four side walls 13 arranged two by two transversely to each other.

As anticipated above, the container 4 has a pickup opening 6. Preferably, the pickup opening 6 allows at least one case 2 to be picked up at a time. In the present case, the pickup opening 6 also allows more than one case 2 to be picked up at a time.

Additionally, the pickup opening 6 is adapted to allow the pickup of the package leaflet 8.

The pickup opening 6 is formed in a position opposite the bottom wall 12.

In the present case, the container 4 has a top wall 14, opposite the bottom wall 12, where the pickup opening 6 is cut out.

The container 4 extends in height between the bottom wall 12 and the pickup opening 6. Moreover, the container 4 extends in width and length along respective transverse directions to each other and to height. Preferably, the pickup opening 6 extends for substantially the entire width and length of the container 4.

The layers defined by the sets of cases 2 are stacked with each other along the height of the container. Instead, the cases 2 of each set of cases 2 are side by side along the width and/or length of the container 4.

Preferably, the container 4 has length of 50 to 60 cm, preferably 52 cm, width of 20 to 40 cm, preferably 31 cm, and height of 20 to 40 cm, preferably 30 cm allowing for an advantageously and overall compact container.

Preferably, the container 4 is made at least partly of cardboard. Even more preferably, the container 4 is made completely of cardboard.

Appropriately, the container comprises a closure element 14 adapted to close the pickup opening 6. The closure element 14 is movable between an opening position, wherein it frees the pickup opening 6 to allow at least one case 2 and/or the package leaflet 8 to be picked up, and a closing position, wherein it closes the pickup opening 6 to prevent a case 2 and/or a package leaflet 8 from being picked up.

Preferably, the closure element 14 coincides with the top wall 14 of the container 4. Specifically, the top wall 14 is connected at one edge of the side wall 13 so that it can rotate between the opening position and the closing position, and vice versa.

Preferably, the closure element 14, in the closing position, makes an interlocking coupling by shape with the side wall 13 of the container 4.

As anticipated above, the package leaflet has a shape substantially complementary to the housing compartment 5. Specifically, the package leaflet has a shape which is substantially complementary to the cross section of the container 4. In this instance, the package leaflet has a shape which is substantially square or rectangular.

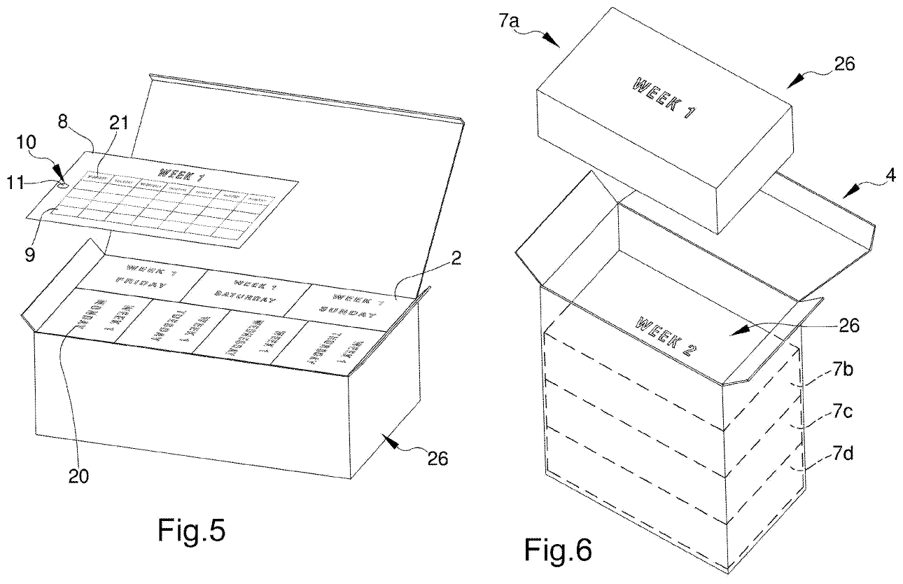

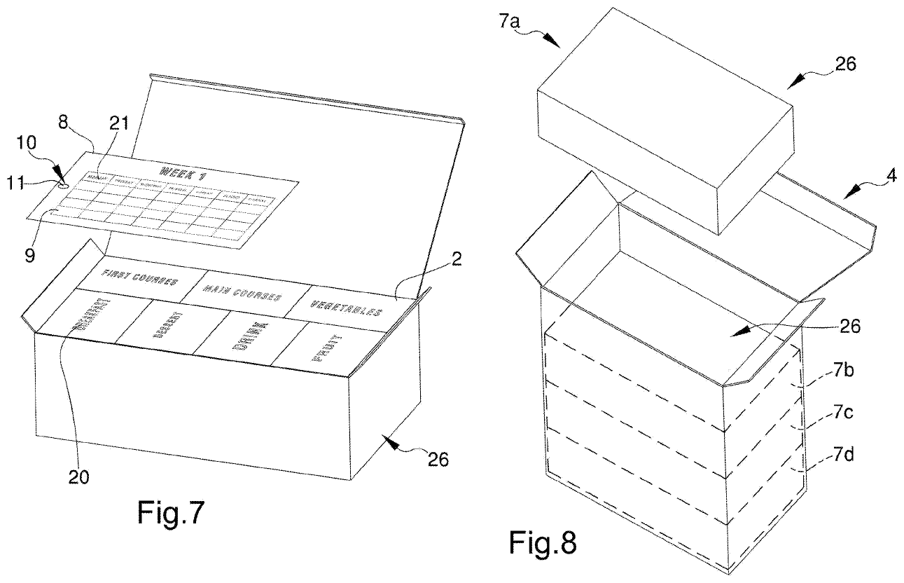

According to one or more of the embodiments shown in FIGS. 5-8, each set of cases 2a-2d is arranged within a respective box-shaped container 26. Each box-shaped container 26, in turn, is arranged within the housing compartment 5 to make one of the layers. Specifically, in such embodiments, the box 1 comprises a plurality of box-shaped containers 26, each containing a respective set of cases 2 and a respective package leaflet 8.

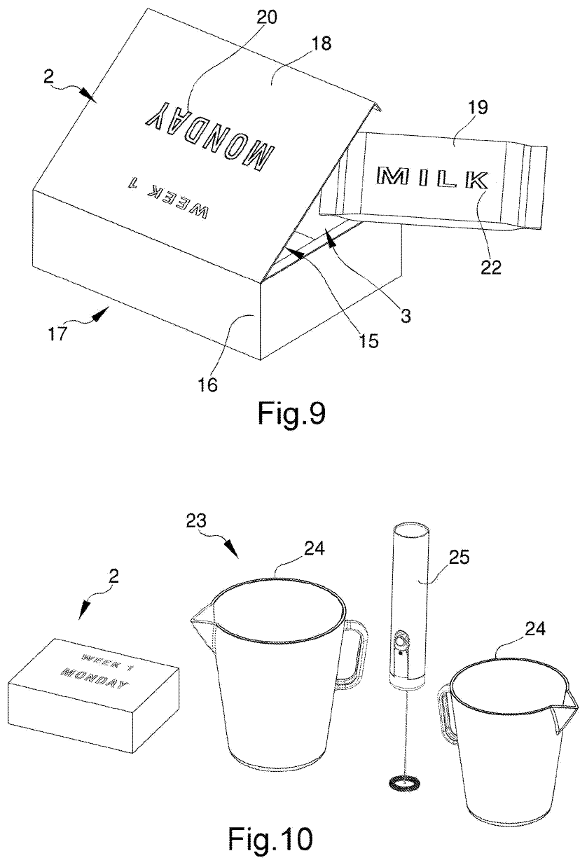

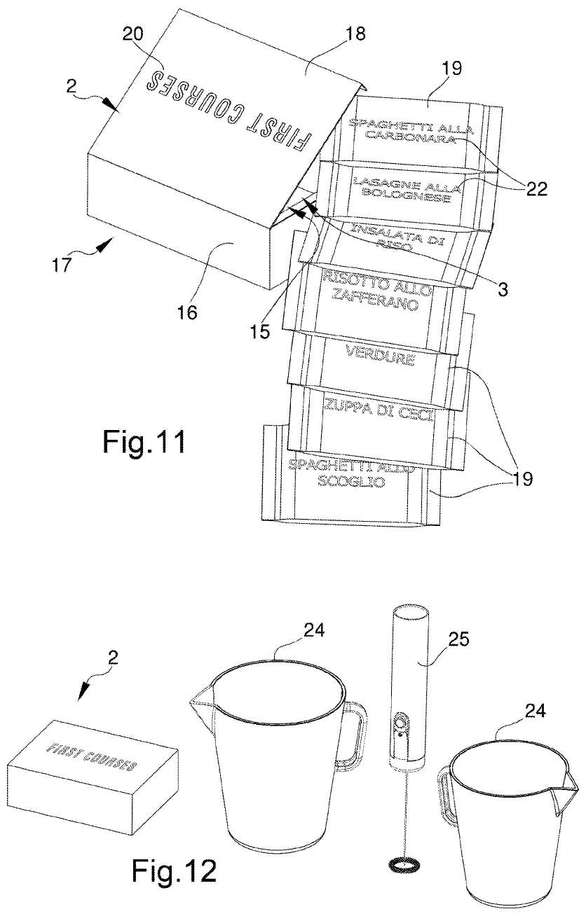

As visible in FIG. 9 or 11, each individual case 2 has a substantially box-shaped shape. In this instance, the case 2 has a substantially parallelepiped shape, preferably in square or rectangular plan. It cannot however be ruled out that the case 2 may have different conformations, such as e.g. a prism-like in triangular or cylindrical plan.

Preferably, each case 2 has length between 10 and 20 cm, preferably 17 cm, width between 9 and 15 cm, preferably 12.75 cm, and height between 5 and 15 cm, preferably 7 cm allowing for an advantageously and overall compact case.

In a preferred embodiment, the organization of the cases 2 in each layer 7a-7d is carried out according to the following pattern: four cases are side by side for the long side and three cases are side by side for the short side so that the long sides of the three cases are side by side with the short sides of the four cases.

Specifically, the case 2 defines at least one compartment 15 adapted to contain at least one food product. In this instance, the case 2 comprises at least one sidewall 16 and one bottom 17 which define the compartment 15.

As anticipated above, the case 2 has an access opening 3. The access opening 3 is cut out in a position opposite the bottom 17. Preferably, the case 2 has an upper wall 18, opposite the bottom 17, at which the access opening 3 is obtained.

The case 2 extends in height between the bottom 17 and the pickup opening 6. In addition, the case 2 extends in width along a direction transverse to height. Finally, the case 2 extends in length along a direction transverse to height and width.

Usefully, the cases 2 of the plurality of cases 2 have dimensions such that the sum of their volumes is slightly less than or substantially equal to the volume of the housing compartment 5.

In addition, the width and length of the cases 2 in each set of cases 2 are such that the sum of their widths is less than or substantially equal to the width of the container and the sum of their lengths is less than or substantially equal to the length of the container.

Preferably, the case 2 is made at least partly of cardboard. Even more preferably, the case 2 is completely made of cardboard.

Appropriately, the case 2 comprises a closing wall 18 adapted to close the access opening 3. The closing wall 18 is movable between an opening position, in which it frees the access opening 3 to allow a product to be picked up, and a closing position, in which it closes the access opening 3, preventing the product from being picked up.

Preferably, the closing wall 18 coincides with the upper wall 18 of the case 2. Specifically, the upper wall 18 of the case 2 is connected at one edge of the sidewall 16 so that it can rotate between the opening position and the closing position, and vice versa.

Preferably, the closing wall 18, in the closing position, makes an interlocking coupling by shape with the sidewall 16 of the case 2.

Appropriately, the case 2 is adapted to contain the food products packaged in sachets 19 in the form of powdered food compositions dissolvable in a reconstitution liquid, preferably water, to obtain a dish having a degree of viscosity between 0 and 4 on the IDDSI scale.

In accordance with one embodiment, each powdered food composition contained in the sachets 19 is dissolvable in a reconstitution liquid to obtain a dish having a degree of viscosity of 2 on the IDDSI scale.

In accordance with a further embodiment, each powdered food composition in the sachets 19 is dissolvable in a reconstitution liquid to obtain a dish having a degree of viscosity of 3 on the IDDSI scale.

Preferably, each case 2 is adapted to contain one or more sachets 19. Each sachet 19 contains a food product which can be associated with a specific dish intended to be enjoyed at a specific time of day within the time period in which the case 2 is intended to be opened.

In detail, in the event of each case 2 being intended to be opened on a specific day, each sachet 19 is opened at a specific time on the relevant day.

Alternatively, in the event of each case 2 being intended to be opened at a specific time, each sachet 19 will always be opened at substantially the same time.

The sachets 19 can then contain at least one type of food product from the following types:
food products for hydration,
food products for breakfast,
food products for lunch,
food products for snack,
food products for dinner.

Preferably, each case 2 comprises at least one sachet 19 for each of the above-mentioned product types.

In accordance with the embodiment shown in the example in FIG. 9 or 11, each case 2 contains seven sachets 19 or multiples thereof. Preferably, each sachet 19 contains its own powdered food composition that is different from the powdered food composition contained in the other sachets 19 of the case 2. Each case 2 may substantially contain seven, fourteen, twenty-one sachets 19 and so on.

Usefully, in order to promote the use by the dysphagic user, the sachets 19 are sorted within the cases 2 according to their order of use. This order of use is also stated on the corresponding package leaflet 8.

Appropriately, each case 2 may have at least one identifying element 20 adapted to identify the case 2 and/or the time period when the case 2 has to be opened.

Preferably, the identifying element 20 may represent the name of the day of the week on which the case 2 is intended to be opened or the name of the dish of a particular meal. For example, with reference to the example shown in FIGS. 3 and 4, the first case 2 of the kit contains the name “BREAKFAST” as identifying element 20, the second case 2 of the kit contains the name “FIRST COURSES”, the third case 2 of the kit contains the name “MAIN COURSES”, the fourth case 2 of the kit contains the name “VEGETABLES”, the fifth case 2 of the kit contains the name “DESSERT”, the sixth case 2 of the kit contains the name “FRUIT” and the seventh case 2 of the kit contains the name “DRINK”.

Usefully, the identifying element 20 can also represent information regarding the food products contained, such as e.g. name, amount and nutritional content.

The identifying element 20 is applied to the case 2 by means of at least one method selected from engraving, printing, silk-screen printing, painting and/or by sticker application.

Preferably, the identifying element 20 is of the type of a label.

Appropriately, the identifying element 20 is attached to the upper wall 18 of the case 2. In this way, when the corresponding package leaflet 8 is removed from the container 4, the identifying element is in view of the dysphagic user.

Usefully, the package leaflet 8 carries at least one identifying character 21 that has an association and/or correlation with the identifying element 20. In addition, the package leaflet 8 carries, in a position associated with the identifying character 21, the information regarding the food product contained in the case 2 to which the identifying element 20 is affixed. In actual facts, for each case, the relevant package leaflet 8 carries the information necessary for the proper enjoyment of the food products contained therein.

This expedient makes it possible to create a unique association between the information on the package leaflet 8 regarding the enjoyment of a particular product and the case 2 in which the product is contained.

In such an event, the package leaflet 8 associated with a predetermined set of cases 2 has at least one identifying character 21 associated with each case 2 of the relevant set of cases 2.

Appropriately, each sachet 19 may comprise at least one distinctive mark 22 adapted to distinguish the different sachets based on at least one of:
the time at which it is to be enjoyed,
the mode of enjoyment, and
the type of products contained.

Preferably, each sachet 19 comprises a corresponding distinctive mark 22.

Preferably, the distinctive mark 22 is applied onto the sachet 19 by means of at least one method selected from engraving, printing, silk-screen printing, painting and/or by sticker application.

Usefully, the distinctive mark 22 can be a certain color applied to the sachet 19. In other words, each sachet 19 has a certain color that allows easy and intuitive distinction of the sachets 19 according to the type of food product contained. The use of different colors for different sachets allows each sachet to be immediately recognized and correlated with the information on the package leaflet 8.

Similarly, the package leaflet 8 comprises at least one distinctive mark, similar or corresponding to the distinctive mark of the sachets 19, that allows immediate correlation between the information on the package leaflet 8 and the sachet 19 to which that information refers.

According to a preferred embodiment, the distinctive mark 22 is used to distinguish the sachets 19 according to the type of products contained.

In accordance with the embodiment, the distinctive mark 22 represents the name of the dish. For example, with reference to the example in FIG. 11, the first sachet 19 of the case 2 relating to “FIRST COURSES” contains the name “SPAGHETTI ALLA CARBONARA” as distinctive mark 22, the second sachet 19 contains the name “LASAGNE ALLA BOLOGNESE” as distinctive mark 22, the third sachet 19 contains the name “INSALATA DI RISO” as distinctive mark 22, the fourth sachet 19 contains the name “RISOTTO ALLO ZAFFERANO” as distinctive mark 22, the fifth sachet 19 contains the name “MINESTRA DI VERDURA” as distinctive mark 22, the sixth sachet 19 contains the name “ZUPPA DI CECI” as distinctive mark 22 and the seventh sachet 19 contains the name “SPAGHETTI ALLO SCOGLIO” as distinctive mark 22.

The possibility cannot, however, be ruled out of having for each case different types of dishes, preferably, at most, equal to seven or multiples thereof. For example, in the instance of the “MAIN COURSES” case, it will be possible to have the first sachet 19 containing the name “COTOLETTA ALLA MILANESE” as distinctive mark 22, the second sachet 19 containing the name “PESCE MARINATO” as distinctive mark 22, the third sachet 19 containing the name “TAGLIATA DI POLLO” as distinctive mark 22 and so on.

In accordance with one embodiment, the distinctive mark 22 may also contain instructions regarding the preparation of meals and/or drinks, the amount of water to be used for reconstitution, etc.

The present invention also relates to a distribution kit for food products. The kit 23 comprises at least one box 1 according to what has been described above. In addition, usefully, the kit 23 comprises at least one of either a jug 24 or a mixer 25. Specifically, the kit 23 comprises at least one a jug 24 and at least one mixer 25. Preferably, the kit 23 comprises a pair of jugs 24 and a mixer 25.

Appropriately, the jug 24 is adapted to be used to dose and prepare the food products.

Conveniently, the mixer 25 is adapted to carry out mixing of the food products.

Usefully, the jug 24 has a system for measuring the volume of the substance with which it is filled. Preferably, such a measuring system comprises one or more notches which allow the filling level of the jug 24 to be correlated with a given volume of the food product contained in the jug 24.

Appropriately, the notches may comprise an indicative element quite similar to the distinctive mark 22 of the sachets 19, or they may provide for a certain color corresponding to one of the colors of the distinctive marks applied to the sachets 19. This expedient makes it possible to be able to immediately determine the amount of the substance containing the food product of a given sachet that is to be placed in the jug 24.

In accordance with one embodiment, the package leaflet 8, the case 2 and/or the sachet 19 may comprise a QR code, or similar code readable by a smart-phone, for downloading an application for the automatic calculation of average daily calories and protein. Appropriately, the access to such an application can be made by connecting to a predefined web page, even from a PC. The application allows a user to make up his or her own menu by choosing and combining the dishes in the kit according to his or her tastes and preferences or even based on the desired nutritional requirements. Advantageously, the menu created with the application is subsequently printable and usable by the user without the need, therefore, to use the pre-printed leaflets.

The operation of the box 1 and/or the kit 23 according to the present invention is as follows.

Once the box 1 and/or the kit 23 has been provided to a dysphagic user or the dysphagic user's caregiver, the latter opens the container 4 and takes out the package leaflet 8 facing the pickup opening 6.

In the event of the container 4 being opened for the first time, the package leaflet 8 is the first package leaflet 8a.

The package leaflet 8 taken out can be hung on a wall, e.g. in the kitchen, so that the dysphagic user can benefit from the information thereon.

After the package leaflet 8 has been taken out, the cases 2 of the corresponding set of cases 2 face the pickup opening 6 so that the dysphagic user, following the instructions given on the package leaflet and/or on the case 2 itself, can take them out in the correct order for their use.

At the point when, according to the instructions, the user is to enjoy a certain food product, the user takes the case containing that food product out of the container.

At this point, the user follows the instructions on the package leaflet 8 to prepare the meal and/or drink.

In this instance, after the case 2 has been opened, the method involves the phases of:
pouring water into the jug 24 until it reaches a predetermined notch, the value of which can be identified in the package leaflet or in the sachet 19 depending on the type of meal and/or drink to be prepared,
picking from the case 2 a sachet 19 identifiable by means of the distinctive mark 22 according to the type of product and/or drink to be prepared,
pouring the contents of the sachet 19 into the jug 24,
dipping the mixer 25 into the jug 24 and turning it on.

The first two phases can be carried out in the reverse order. The last two phases can be carried out simultaneously.

Depending on the type of meals and/or drinks to be prepared, the user can use cold, room temperature or heated water (with temperatures preferably between 30° C. and about 100° C.).

In the event of preparing drinks for hydration, the distinctive mark 22 is the color orange and the water to be poured into the jug is cold or room temperature water.

In the event of preparing meals for breakfast, lunch, and dinner, the distinctive mark 22 is the color white, and the method involves an additional phase of bringing the water to the boiling point. This phase is prior to the phase of pouring the water into the jug.

Appropriately, the preparation of meals and/or drinks may involve combining the food products contained in the box 1 with other food products which are usually present in a user's kitchen, such as oil, cheese, and so on.

After the dysphagic user has finished enjoying a sachet 19 taken from a first case 2, e.g., the one relating to the “FIRST COURSES”, the user can take a sachet 19 from a second case 2, e.g., the one relating to the “MAIN COURSES”, and enjoy its contents in the same manner as described above. This process is repeated until the user finishes his or her meal.

Preferably, in the event of a meal using two or more sachets, the phase of dissolving in a reconstitution liquid the composition of the sachet 19 selected from the next case 2 occurs no more than 30 minutes after the phase of dissolving in a reconstitution liquid the composition of the sachet 19 selected from the first case 2.

After the dysphagic user has finished enjoying the first set of cases 2a, the package leaflet 8 of the second set of cases 2b faces the pickup opening 6. At this point, the user can pick up the second package leaflet 8 and begin to enjoy the second set of cases 2b in the same manner as described above in relation to the first set of cases 2a. This process is repeated as far as the user makes use, in the month, of the last set of cases 2 which is arranged against the bottom wall 12.

It has in practice been ascertained that the described invention achieves the intended objects, and in particular the fact is emphasized that, by means of the box according to the invention, it is possible to distribute food products by means of an expedient that makes it possible to help the dysphagic user to enjoy them independently and properly in an adaptable and modular configuration both for monthly supplies as well as for weekly supplies of food products.

1. A box for supplying food products for dysphagic users, said box comprising:
a plurality of cases organized in layers, each case of said plurality of cases containing at least one food product to be supplied to a dysphagic user and which can be picked up by means of an access opening,
a container which defines at least one housing compartment of said plurality of cases and a pickup opening, wherein
said plurality of cases of said a first set are distributed in a respective first layer,
said plurality of cases of said a second set are distributed in a respective second layer, and
said first layer is positioned between said pickup opening and said second layer,
each individual case is picked up at a first time range and a case adjacent thereto is picked up at a second time range, subsequently to the first time range.

2. The box according to claim 1,
wherein said first set of cases is picked up at a first time range, and said second set of cases is picked up at a second time range, subsequently to said first time range.

3. The box according to claim 1, further comprising: at least one package leaflet associated with one of said sets of cases and positioned between one of said sets of cases and said pickup opening, said package leaflet bearing at least one piece of information instruction concerning the products contained in said relevant set of cases.

4. The box according to claim 3, further comprising: at least a first package leaflet, associated with said first set of cases, and a second package leaflet associated with said second set of cases, said first package leaflet being positioned between said pickup opening and said first layer, said second package leaflet-being positioned between said first layer and said second layer.

5. The box according to claim 1, wherein each of said sets of cases comprises at least a first case, intended to be opened at a first time period, and a second case intended to be opened at a second time period, subsequently to said first time period, and
said first case and said second case being arranged side by side to make said relevant layer.

6. The box according to claim 1, wherein said plurality of cases comprises:
a third set of cases intended to be picked up at a third time range, subsequently to said second time range, and
a fourth set of cases intended to be picked up at a fourth time range, subsequently to said third time range.

7. The box according to claim 1, wherein each set of cases comprises seven cases.

8. The box according to claim 5, wherein said first time range or said second time range lasts one week and said first time period or said second time period lasts one day.

9. The box according to claim 1, wherein at least one of said cases has an identifying element adapted to identify said case and/or a time period when said case has to be opened.

10. The box according to claim 1, wherein each of said cases contains at least one sachet containing a different food product in a form of powdered food composition.

11. The box according to claim 1, wherein each of said cases contains seven sachets or multiples thereof.

12. The box according to claim 10, wherein said powdered food composition is dissolvable in a reconstitution liquid to obtain a dish having a degree of viscosity between 0 and 4 on the IDDSI scale.

13. The box according to claim 11, wherein each sachet comprises at least one distinctive mark adapted to distinguish the different sachets from each other.

14. A method for supplying food products for dysphagic users, said method comprising:
having a plurality of cases contained in a container, wherein each of said cases comprises:
at least one identifying element adapted to identify said case and/or the time period in which said case has to be opened, and
at least one sachet containing a different food product in a form of powdered food composition to be supplied to a dysfagic user, wherein
said plurality of cases comprise a first set of cases and a second set of cases; and
said cases of said first set are distributed in a respective first layer and said cases of said second set are distributed in a respective second layer, and
picking at least one case according to a predetermined order defined by said identifying element,
opening said at least one case to pick up at least said sachet,
opening said sachet and dissolving the content thereof in a reconstitution liquid.

15. A kit for the distribution of food products according to claim 1, said kit comprising said box, a jug and a mixer.
